(19) United States
(12) Patent Application Publication
(10) Pub. No.: US 2023/0051736 A1
(43) Pub. Date: Feb. 16, 2023

(54) Combinable dual cremation urns

(71) Applicant: Richard H. Ebbott, Flint, MI (US)

(72) Inventor: Richard H. Ebbott, Flint, MI (US)

(21) Appl. No.: 17/358,285

(22) Filed: Jun. 25, 2021

(51) Int. Cl. A61G 17/08

(52) U.S. Cl. CPC A61G 17/08

(57) ABSTRACT

A system consisting of two urns each being capable of containing the cremated remains (cremains) of one person. Each urn is the mirror image of the other urn. Each urn has a base that will support it standing alone. Each urn has an opening with a plug or cover to fit securely in the opening. The opening will allow the cremains to be placed within the urn. The plug or cover will create an airtight seal. Each urn will have an area to affix a means to identify the cremains. Each urn will have a part of the common area which is removeable to allow the contents of the two urns in the system to co-mingle when joined. Each urn will have a common surface area that will permit the two urns to be permanently sealed together to form one unit.

### FIELD OF THE INVENTION

This invention relates generally to urns designed to store cremated remains and more specifically to a system of dual urns each designed to separately contain one set of cremains and each designed to be permanently attached to the other with a common opening between them together with an area for a device to identify the cremains within.

### BACKGROUND OF THE INVENTION

Especially with the Church allowing cremation of a deceased body and with the increased desire for cremation instead of inhumation or mausoleum placement of the body, together with the need for more burials in less space, the demand for cremation urns has greatly increased and will continue to do so. This invention presents a unique system where the first of the urns can be utilized when a loved one passes away to contain that person’s cremains for funeral or other memorial service and later for retention at home or other place, or for deposit in a cemetery mausoleum or even for burial. An area of the urn will allow a device to identify and otherwise memorialize the cremains.

When the other loved one passes away the second of the dual urns, being a mirror image of the first, is utilized to contain the cremains of that person with like identifying device. The tow urns can then be brought to a common place where the removal portion of each urn can be removed and the two urns can then be permanently joined allowing the cremains of each to comingle. The system of the dual urns now joined can be displayed, placed in a mausoleum or buried.

The inventor had in mind when creating this invention that it would be desirable for a married couple who would wish to remain together after death, but the invention is likewise suitable for one person and a pet or the cremated remains of any two living things.

### SUMMARY OF THE INVENTION

In one aspect of this invention the system of dual cremation urns is shaped to form when combined a heart on a base. Each urn in the system is a mirror image of the other urn. Each urn is designed and has a sufficient base to stand upright on its own and is of sufficient size and interior capacity to contain the cremated remains (cremains) of one human being. Each urn has an opening for receiving the cremains and which opening can them be permanently sealed airtight. Each urn has an area where a medallion or other device can be affixed to identify and otherwise memorialize the cremains therein. On the common face of each urn is an area that is designed to be removed just prior to the two urns in the system being permanently joined at the common face.

As one example, the system of dual urns can be fabricated of hollow molded ceramic material with all visible surfaces being suitably glazed. The opening to receive the cremains can be sealed with a plug or cap of the same or different material of such a size and shape that an airtight seal is created. The medallion or other identifying device can be affixed to the plug or cap or can be affixed elsewhere on the urn. It is thought that during the formation process the common face will have an area that is thinner than the rest of said common face such that the thinner area can be easily removed from the common face just prior to the two common faces of the dual urns of the system being permanently joined.

In other examples the system of the combined ceramic urns can be shaped like a vase, like a covered pot, like a barrel or of any other desired configuration for the final form. Further the urns can be fabricated out of wood or metal or any other material which is sufficiently rigid to hold its shape and to contain the cremains and which will not deteriorate over time even if buried in the ground.

In another aspect of the invention there is s system of three or more urns designed to be pieces of the common whole each urn having two common faces with two other urns in the system. And each of the common faces will have an area designed to be removed when the urns are permanently joined. For example, if the system was shaped like a barrel it would have a circular shape when viewed from above and each urn in the system would be a segment of that circle.

In another aspect of the invention the system of urns can be designed to be a series of urns each with two common faces. The series can be a continuous line of urns with common face at right angles to the front of the urns and with no limit to the number of urns in the system. Or the system can be designed with common faces angled in relation to the front of the urns such that a predetermined number of urns will allow the last urn in the system to combine with the first urn.

### BRIEF DESCRIPTION OF THE DRAWINGS

FIG. 1 is a front view of the system of dual cremations urns together.

FIG. 2 is an end view of the urn on the right side of the system.

FIG. 3 is a perspective view of the urn on the right side of the system.

### DETAILED DESCRIPTION OF THE DRAWINGS

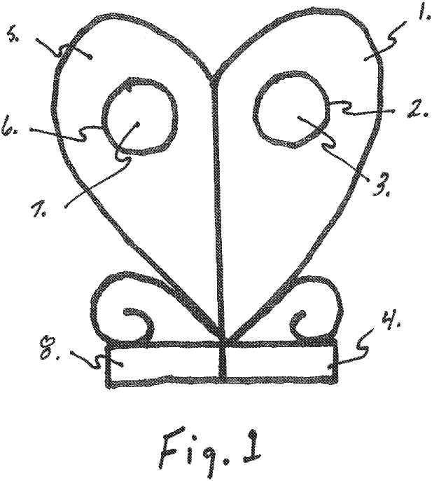

Referring to FIG. 1 there is illustrated a system of two cremation urns 1 and 5 designed as mirror images of each other with a side of each designed to be permanently adhered to the corresponding side of the other urn in the system. Each urn is of sufficient size to accommodate the cremains of one person. Each urn has a base 4 and 8 sufficient to support that urn standing alone. Each urn has an opening 2 and 6 sufficient to receive the cremains. Each urn has a plug or cap 3 and 7 that will fit into the opening 2 and 6 to permit an airtight seal to be created.

The design in FIG. 1 is only illustrative and the system can be of any design and made of any materials suitable for the purpose.

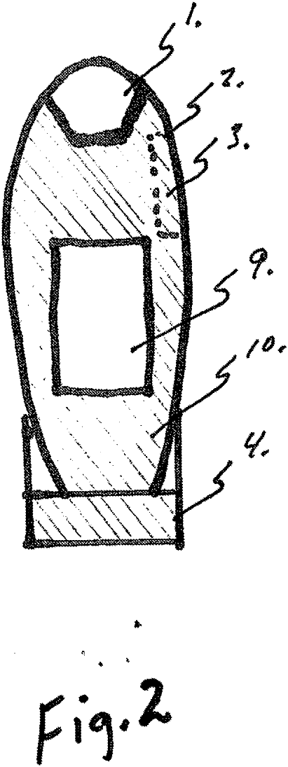

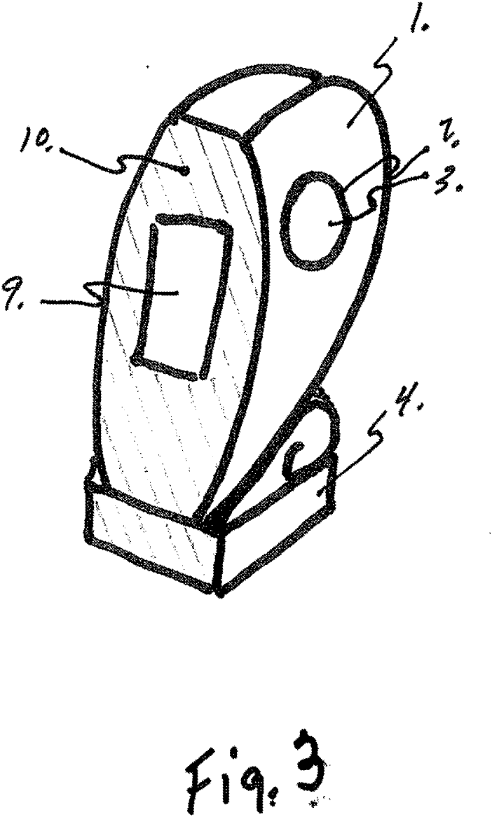

Referring to FIGS. 2 and 3 there is illustrated the urn on the right side of the system.1. The urn in FIGS. 2 and 3 has a base of sufficient size and location to permit the urn to stand upright 4. The urn on the left side of the system is a mirror image of FIGS. 2 and 3. There is illustrated the opening of sufficient size to receive the cremains 2 and the plug or cap 3 to fit within said opening and allow an airtight seal to be created. There is further illustrated an area of the urn 1 within the side designed to be fitted and sealed to the left urn in the system that is removeable 9. Finally there is an area of the urn 1 that is flat 10 (cross-hatched) and which is designed to correspond and fit tightly to the corresponding area of the left urn of the system such that the two urns can be joined and permanently sealed together.

What is claimed:

1. A system consisting of two urns each urn being capable of containing the cremated remains (cremains) of one person and each urn being the mirror image of the other urn. Each urn can be of any shape or style and made out of any suitable material. Each urn has a base that will support it standing alone. Each urn has an opening with a plug or cover to fit securely in the opening and which opening will allow the cremains to be placed within the urn and then have inserted and secured the plug or cover in such manner as to create an airtight seal. Each urn will have an area, on the plug or cover or elsewhere, to affix a medallion or other means to identify the cremains therein. Further each urn will have an area of the surface that joins the other urn in the system which area is removeable to allow the contents of the two urns system to co-mingle when joined. Finally the two urns have areas of the surface that correspond to the like surface of other urn in the system that will permit the two urns to be permanently sealed together to form one unit.

2. The combination of claim 1 except the system consists of three or more urns which when joined together comprise a single shape, such as a barrel or a vase.

3. The combination of claim 1 except the system consists of three or more urns each of which has sufficient flat areas on opposing sides to accommodate a removable area and which has sufficient remaining flat area to be joined to another urn in the system.
